(19) United States
(12) Patent Application Publication
(10) Pub. No.: US 2024/0286295 A1
(43) Pub. Date: Aug. 29, 2024

(54) GRIPPERS AND PLY SEPARATION METHODS

(71) Applicants: Demitri Balabanov, Everett, MA (US); Troy Coverstone, Douglas, MA (US); Michael Dabrowski, North Grosvenordale, CT (US)

(72) Inventors: Demitri Balabanov, Everett, MA (US); Troy Coverstone, Douglas, MA (US); Michael Dabrowski, North Grosvenordale, CT (US)

(21) Appl. No.: 18/587,901

(22) Filed: Feb. 26, 2024

Related U.S. Application Data
(60) Provisional application No. 63/486,956, filed on Feb. 24, 2023.

(51) Int. Cl. B25J 15/06; B65H 3/08

(52) U.S. Cl. CPC B25J 15/0616; B65H 3/0816

(57) ABSTRACT

An air gripper having a body, an upper cover releasably coupled to a first surface of the body, a lower cover releasably coupled to a second surface of the body, and a through-hole extending through the body, upper cover, and lower cover, is disclosed. An edge gripper having an upper body, a lower body releasably coupled to the upper body, a guide attachment releasably coupled to the front face of the upper body, and a vent positioned between the front face of the upper body and the guide body of the guide attachment, is disclosed. A destacker assembly having a carriage, an edge gripper coupled to the carriage, and a finger coupled to the carriage, is disclosed. Methods of using the air gripper, the edge gripper, and destacker assembly to move and/or a ply of material from a stack having a plurality of plies are disclosed.

### CROSS-REFERENCE TO RELATED APPLICATIONS

This application claims the benefit of priority under 35 U.S.C. § 119(e) of U.S. Provisional Application Ser. No. 63/486,956, filed on Feb. 24, 2023, the content of which is relied upon and incorporated herein by reference in its entirety.

### FIELD

This disclosure relates to robotic arm end effectors, and more particularly to gripping devices and methods of using the gripping devices to lift, separate, and/or move objects.

### BACKGROUND

A robotic arm is a programable, mechanical arm with functionality similar to a human arm. Robotic arms can be used in various manufacturing processes to handle (e.g., lift, transport) objects in its work environment. The device at the end of a robotic arm that interacts with the objects is called an end effector. There are different types of end effectors for carrying out particular functions, but the end effector will generally include a tool or gripper. Some objects are difficult to handle because they are inherently flexible, slippery, fragile, etc. Accordingly, there remains a need in the art for end effectors having improved functionality.

### SUMMARY

In various embodiments, an air gripper configured to lift an object is described. In some embodiments, the gripper comprises a body having an annular shape modified by a joint projecting from a side of the body; an upper cover releasably coupled to a first surface of the body; a lower cover releasably coupled to a second surface of the body; and a through-hole extending through the body, the upper cover, and the lower cover, the through-hole having a truncated conical shape defined by a base at the second surface of the body and an apex at the first surface of the body; wherein the body comprises a pocket configured to receive an input of gas and an annular channel in fluid communication with the pocket; and wherein the annular channel is in fluid communication with a surface of the through-hole via a gap between the body and the lower cover.

In some embodiments, the truncated conical shape of the through-hole defines an interior annular surface of the body, the interior annular surface being pitched at an angle in a range of 30-80 degrees from the base to the apex.

In some embodiments, the interior annular surface has a slope at an angle in a range of 40-60 degrees from the base to the apex.

In some embodiments, the pocket is centered between lateral edges of the joint and positioned at least partially within the joint.

In some embodiments, the lower cover comprises one or more crossbars extending over the through-hole from one side of the lower cover to an opposite side.

In some embodiments, the gripper further comprises an annular spacer between the lower cover and the body.

In some embodiments, the spacer has a thickness that defines the gap between the body and the lower cover.

In some embodiments, a suction for lifting the object is created in the through-hole when the input of gas flows from the pocket through the annular channel, through the gap between the body and the lower cover, and to the interior annular surface of the body.

In various embodiments, an edge gripper configured to lift an edge of an object is described. In some embodiments, the edge gripper comprises an upper body comprising a top face having an access well configured to receive an input of gas, the well being in fluid communication with a gas storage located within an interior core of the upper body, and the gas storage being in fluid communication with a duct extending from the gas storage to a front face of the upper body; a lower body releasably coupled to the upper body at a bottom face opposite the top face, the lower body comprising a conduit having an first opening on a front face corresponding to the front face of the upper body, wherein the conduit extends through the lower body to a second opening adjacent to a rear face of the lower body opposite the front face; a guide attachment releasably coupled to the front face of the upper body, the guide attachment having a plurality of tines projecting downward from a guide body and curving toward a cross member positioned in proximity to the first opening of the conduit in the lower body; and a vent positioned between the front face of the upper body and the guide body of the guide attachment, the vent being in fluid communication with the duct in the upper body.

In some embodiments, the lower body comprises a sidelong J-shape with a curve of the sidelong J-shape ending at the second opening of the conduit; and wherein the lower body further comprises a curved protrusion on the front face, the curved protrusion being adjacent to the first opening of the conduit.

In some embodiments, respective tines of the plurality of tines on are spaced apart from one another by a spaced distance that defines a plurality of gaps, wherein respective gaps of the plurality of gaps are positioned between adjacent tines.

In some embodiments, the edge gripper further comprises a plurality of fins projecting outward from the front face of the upper body.

In some embodiments, the plurality of fins are spaced apart from one another by a spaced distance that defines a plurality of channels, wherein the respective channels are positioned between adjacent fins.

In some embodiments, the guide body of the guide attachment is in contact with the plurality of fins.

In some embodiments, a suction for lifting the edge of the object is created in the conduit of the lower body when the input of gas flows from the gas storage through the duct, through the vent between the upper body and the guide assembly, and along the curved protrusion on the front face of the lower body toward the first opening of the conduit.

In some embodiments, the edge gripper further comprises a spacer positioned between the upper body and the guide attachment, wherein the thickness of the spacer defines the vent between the front face of the upper body and the guide body of the guide attachment.

In various embodiments, a destacker assembly is described. In some embodiments, the destacker assembly comprises a carriage, an edge gripper coupled to a first face of the carriage, and a finger coupled to the first face of the carriage; wherein the edge gripper comprises: an upper body comprising a top face having an access well configured to receive an input of gas, the well being in fluid communication with a gas storage located within an interior core of the upper body, and the gas storage being in fluid communication with a duct extending from the gas storage to a front face of the upper body; a lower body releasably coupled to the upper body at a bottom face opposite the top face, the lower body comprising a conduit having an first opening on a front face corresponding to the front face of the upper body, wherein the conduit extends through the lower body to a second opening adjacent to a rear face of the lower body opposite the front face; a guide attachment releasably coupled to the front face of the upper body, the guide attachment having a plurality of tines projecting downward from a guide body and curving toward a cross member positioned in proximity to the first opening of the conduit in the lower body; and a vent positioned between the front face of the upper body and the guide body of the guide attachment, the vent being in fluid communication with the duct in the upper body; and wherein the finger comprises a top face having an access well for receiving an input of gas, the well being in fluid communication with a passage within an interior core of the finger, and the passage being in fluid communication with an outlet that can release the gas via a bottom face of the finger, the bottom face being opposite to the top face; and wherein the carriage comprises a first bracket for coupling the edge gripper to the first face of the carriage and a second bracket for coupling the finger to the first face of the carriage.

In some embodiments, the finger and second bracket are moveable about the first face of the carriage, and wherein the finger and second bracket are configured to move laterally toward and away from the edge gripper.

In some embodiments, the edge gripper and the finger are configured to lift and move a single ply of a material from a stack having multiple plies of the material.

In some embodiments, the edge gripper and the finger are configured to separate a first ply of a material from one or more other plies of the material.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein and, together with the description, explain the principles and operations of the claimed subject matter.

### BRIEF DESCRIPTION OF THE DRAWINGS

A complete understanding of the present embodiments and the advantages and features thereof will be more readily understood by reference to the following detailed description, appended claims, and accompanying drawings, wherein:

FIG. 1 is a top view of an air gripper, in accordance with embodiments described herein;

FIG. 2 is a cross-sectional side view of the air gripper of FIG. 1, taken along the A-A′ line in FIG. 1;

FIG. 3 is a bottom perspective view of the air gripper of FIG. 1;

FIG. 4 is an exploded view of the bottom perspective view of FIG. 3;

FIG. 5 is a bottom perspective view of the air gripper of FIG. 1, in accordance with embodiments described herein;

FIG. 6 is bottom view of the air gripper of FIG. 1, in accordance with embodiments described herein;

FIG. 7 is a cross-sectional side view of the air gripper of FIG. 6, taken along the B-B′ line in FIG. 6;

FIG. 8 is a top perspective view of an edge gripper, in accordance with embodiments described herein;

FIG. 9 is a left side view of the edge gripper of FIG. 8;

FIG. 10 is a front elevation view of the edge gripper of FIG. 8;

FIG. 11 is a rear elevation view of the edge gripper of FIG. 8;

FIG. 12 is a top plan view of the edge gripper of FIG. 8;

FIG. 13 is a cross-sectional view of the edge gripper of FIG. 8, taken along the C-C′ line in FIG. 12;

FIG. 14 is an exploded top perspective view of the edge gripper of FIG. 8;

FIG. 15 is a top perspective view of a destacker system, in accordance with embodiments described herein;

FIG. 16 is a side view of the destacker system of FIG. 15;

FIG. 17A, FIG. 17B, FIG. 17C, and FIG. 17D are side perspective views of the destacker system of FIG. 15 in use, in accordance with embodiments described herein; and

FIG. 18A, FIG. 18B, FIG. 18C, and FIG. 18D are side perspective views of the destacker system of FIG. 15 in use, in accordance with embodiments described herein.

The drawings are not necessarily to scale, and certain features and certain views of the drawings may be shown exaggerated in scale or in schematic in the interest of clarity and conciseness.

### DETAILED DESCRIPTION

Reference will now be made in detail to the exemplary embodiment(s), examples of which is/are illustrated in the present disclosure. An embodiment refers to a particular feature or characteristic used in connection with a product or method step described herein. References to an “embodiment” appear throughout the disclosure, and such references are not necessarily referring to the same embodiment or to separate, mutually exclusive embodiment. Generally, the embodiments reside in combinations of components, subcomponents, and/or procedures related to robotic arm devices. Accordingly, the product and method components have been represented where appropriate, showing only those specific details that are pertinent to understanding the embodiments of the present disclosure so as not to obscure the disclosure with details that will be readily apparent to those of ordinary skill in the art having the benefit of the description herein. The specific details of the various embodiments described herein are used for demonstration purposes only, and no unnecessary limitation or inferences are to be understood therefrom.

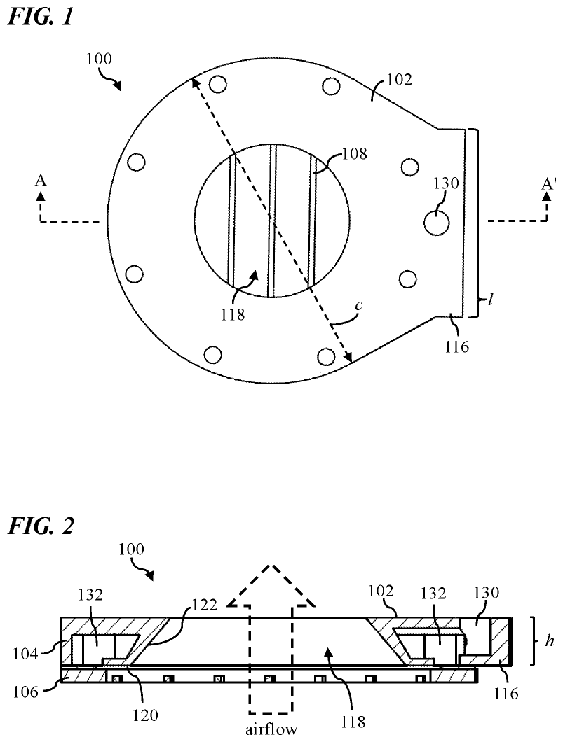

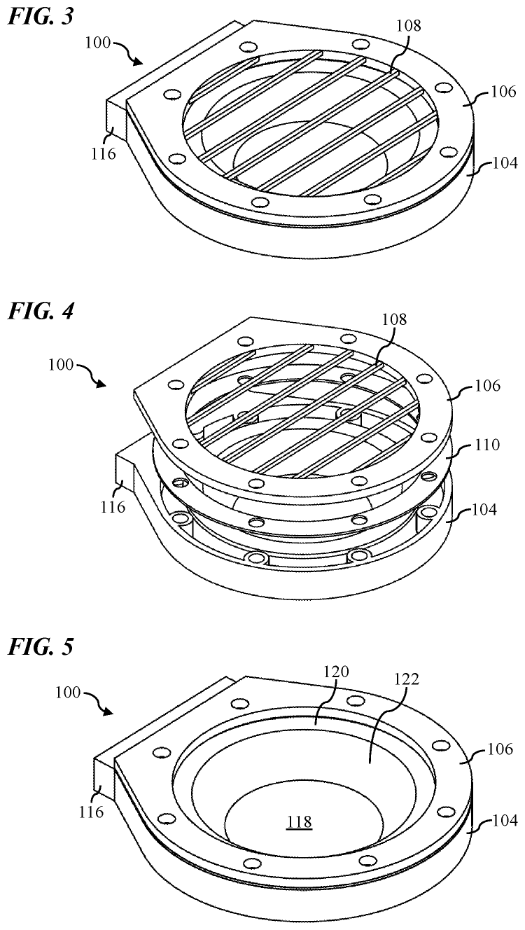

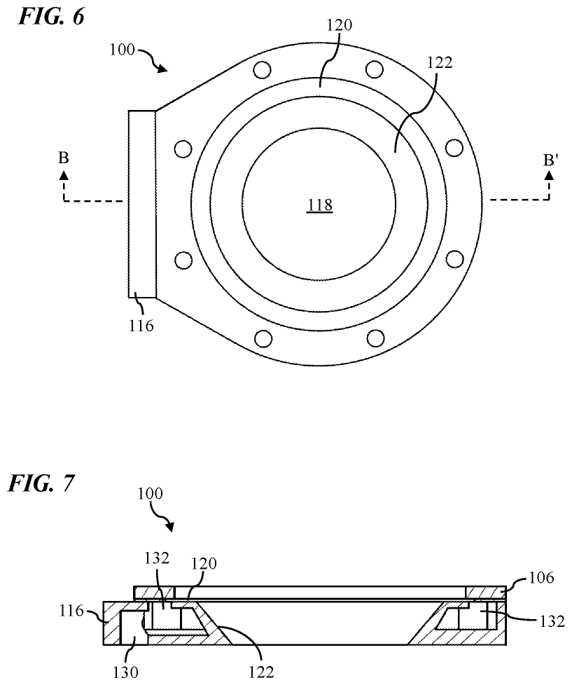

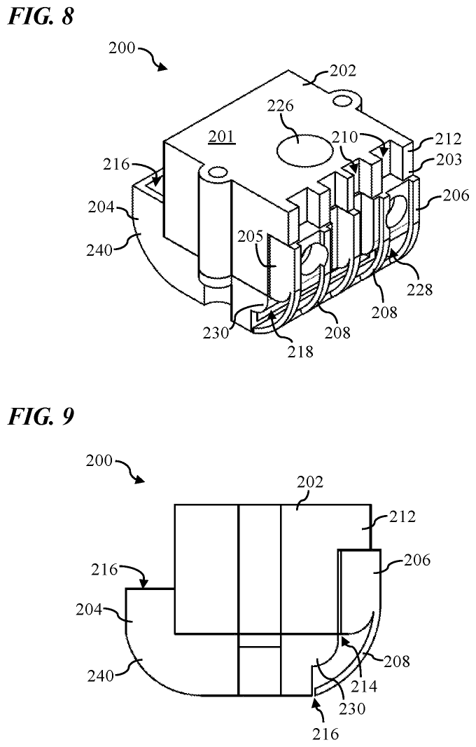

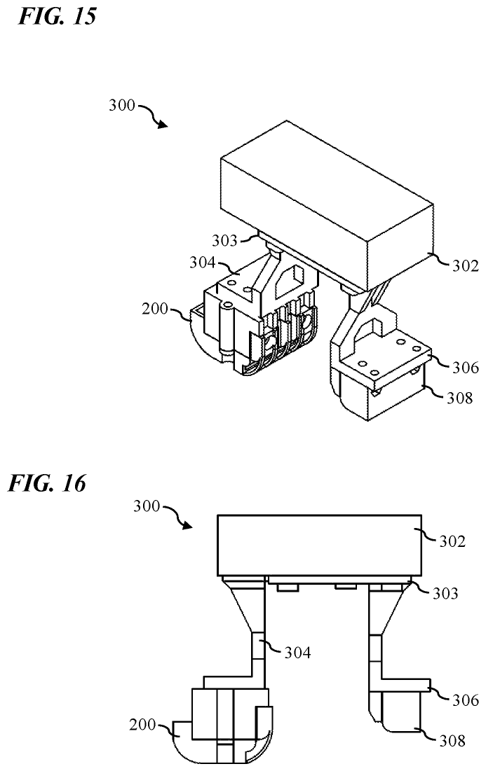

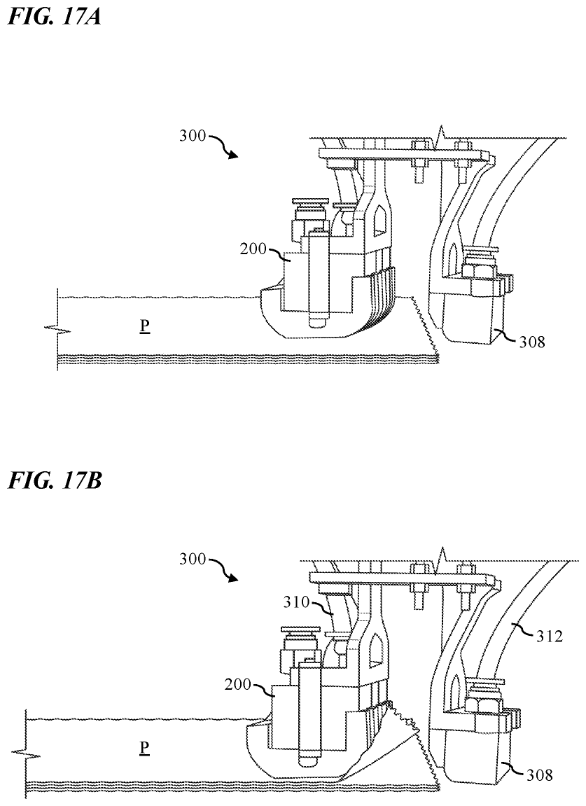

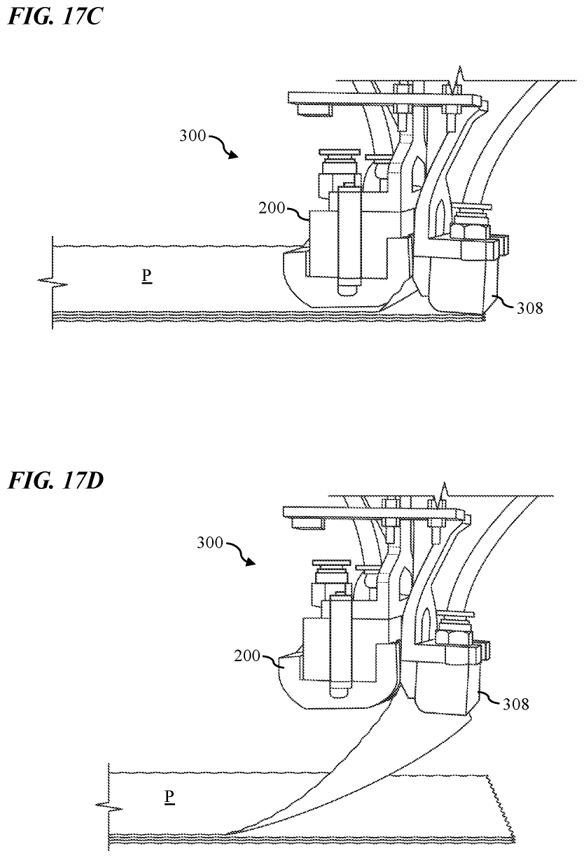

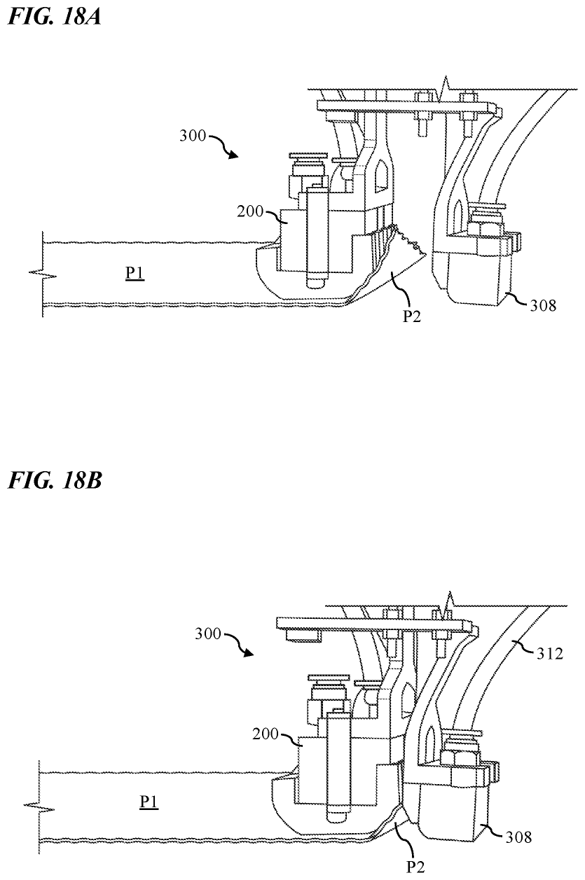

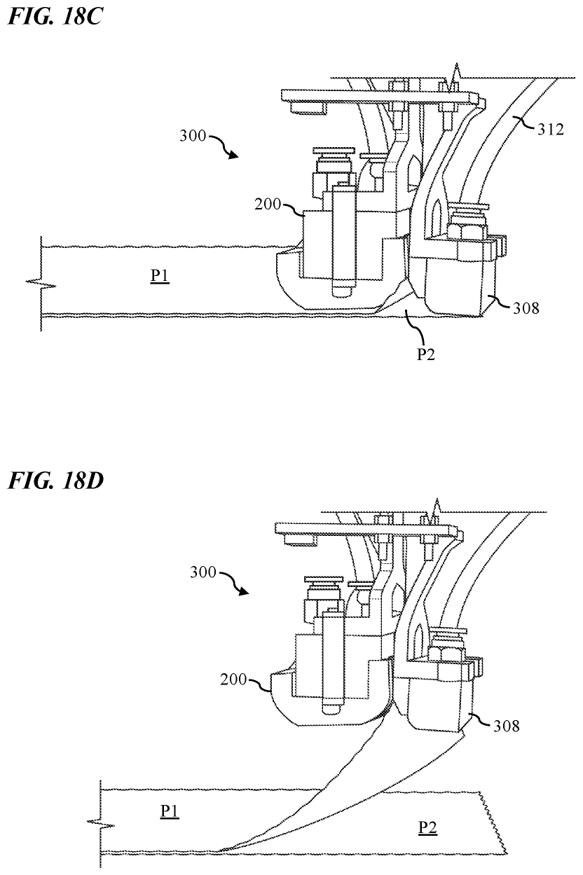

In various embodiments, as shown in FIGS. 1-18D, one or more robotic arm devices are disclosed. In some embodiments, as shown in FIGS. 1-7, an air gripper is disclosed. In some embodiments, as shown in FIGS. 8-14, an edge gripper device is disclosed. In some embodiments, as shown in FIGS. 15-16, a destacking system is disclosed. In some embodiments, as shown in FIGS. 17A-18D, a method of using the destacking system is disclosed.

In various embodiments, as shown in FIGS. 1-7, an air gripper 100 is disclosed. In some embodiments, the air gripper 100 comprises a plurality of components that are operatively coupled together to provide a functional gripping device. In some embodiments, for example, the gripper 100 comprises a body 104, an upper cover 102 configured to releasably couple to an upper (first) surface of the body 104, and a lower cover 106 configured to releasably couple to a lower (second) surface of the body 104.

As used herein, the term “annular” is not limited to a circular ring structure. As used herein, “annular” refers to closed-loop structure having, e.g., a circular, oval, triangular, rectangular, pentagonal, hexagonal, heptagonal, octagonal, etc., cross-sectional shape. Each cross-sectional shape has a corresponding three-dimensional shape (e.g., circular and cylindrical; rectangular and rectangular prism). As used herein, the term “annular” refers to the general cross-sectional or three-dimensional shape of the body 104, upper cover 102, and lower cover 106, and does not modify the other components, including the internal features of the air gripper 100.

In various embodiments, as shown in the figures, the air gripper 100 comprises a generally annular or cylindrical three-dimensional shape. In some embodiments, the generally cylindrical three-dimensional shape is defined by a height h and a circumference c, as shown in FIGS. 1 and 2. In some embodiments, the circumference c is substantially greater than the height h such that the gripper 100 has a puck shape. In some embodiments, for example, the gripper 100 has a height h in the range of 5 mm to 50 mm. In some embodiments, for example, the gripper 100 has a circumference c in the range of 20 mm to 200 mm.

In some embodiments, the generally annular or cylindrical shape is modified by a joint 116 projecting from a slightly elongated side of the body 104. For example, as shown in FIGS. 1-7, the joint 116 projects outward from the body 104. In some embodiments, the joint 116 has a length l. In some embodiments, the joint 116 has a length l in the range of 10 mm to 100 mm. As shown in FIG. 2, in some embodiments, the joint 116 has a thickness that is identical to that of the body 104. In some embodiments, the joint 116 is sized and shaped for coupling to a robotic arm.

In some embodiments, the joint 116 includes an open-area pocket 130 embedded at least partially therein. In some embodiments, as shown in FIG. 1, the pocket 130 is centered between the lateral edges of the joint 116. In such embodiments, the pocket 130 is configured to receive and store a predetermined volume of gas, such as compressed air. In some embodiments, the pocket 130 is in fluid communication with an annular channel 132 that is embedded in the body 104. In some embodiments, the joint 116 is configured so air contained within the pocket 130 can flow into the channel 132. The pocket 130 and annular channel 132 can have any suitable shape and geometry. In some embodiments, the compressed air has pressure in the range of 10-150 PSI, 20-120 PSI, 30-100 PSI, or any subranges (e.g., 41-88 PSI) or specific values (e.g., 45, 55, 65) therein.

In various embodiments, the gripper 100 comprises a through-hole 118. In some embodiments, the through-hole 118 extends throughout the gripper 100, from an external surface on the upper, first surface of the body 104, or an external surface of the upper cover 102, to an external surface on the lower, second surface of the body 104, or an external surface of the lower cover 106, as shown in FIGS. 1-7. In some embodiments, the through-hole 118 has a truncated conical shape as it extends throughout the gripper 100, the conical shape having a base at the lower, second surface and an apex at the upper, first surface of the body 104. In some embodiments, the circumference of the truncated conical shape of the through-hole 118 is defined by an angled interior surface 122, whereby the circumference of the angled interior surface 122 decreases as the through-hole 118 extends from the lower, second surface of the body 104 to the upper, first surface of the body 104 and the upper cover 102.

In some embodiments, as shown in FIG. 4, the gripper 100 comprises a spacer 110 positioned between the body 104 and the lower cover 106. In some embodiments, the spacer 110 is configured with a thickness that can create a thin gap between the body 104 and the lower cover 106 through which air may flow. In some embodiments, the thickness of the spacer 110 determines the size of the thin gap. In some embodiments, for example, the spacer 110 has a thickness in the range of 0.01 mm to 1 mm. In some embodiments, the spacer 110 is a discrete component. In alternative embodiments, the spacer 110 is integrated into and indivisible from the body 104. In some embodiments, the spacer 110 is configured to provide an air-tight seal for the gripper 100 and prevent air from escaping through the thin gap.

In some embodiments, as shown in FIG. 2, the thin gap created by the spacer 110 between the body 104 and the lower cover 106 creates a lip 120. In some embodiments, the lip 120 is adjacent to a lower edge of the angled interior surface 122. In such embodiments, the gripper 100 is configured to guide the flow of air along the surface of the lip 120 and then the angled interior surface 122. In some embodiments, the lip 120 is in fluid communication with the annular channel 132. In such embodiments, the gripper 100 is configured so air contained within the pocket 130 can flow into the channel 132, then to the lip 120, then along the angled interior surface 122, before exiting through the through-hole 118. The lip 120 can be any suitable length. In some embodiments, the lip 120 has a length in the range of 2-10 mm, or 3-8 mm, or any specific length therein, including, for example, 4 mm, 5 mm, 6 mm, etc. The angled interior surface 122 can have any suitable slope angle. In some embodiments, for example, the angled interior surface 122 has an angle in the range of 20-60 degrees, 30-50 degrees, any specific angle therein (e.g., 35, 38, 40, 42 degrees), or the slope can be comprised of two or more combinations of angles.

In various embodiments, as indicated by the arrow labeled “airflow” in FIG. 2, the gripper 100 is configured to create a flow of air that can be used for gripping objects. During use, in some embodiments, the gripper 100 is configured to receive compressed air as an input and output a thin sheet of air that runs parallel to the lip 120 before being curved and exhausted upwards along the angled interior surface 122. Specifically, compressed air fills the pocket 130 and the channel 132 and builds up pressure before exiting through a thin opening to the lip 120. The exiting, thin sheet of air runs parallel to the lip 120. When the thin sheet of air runs over the lip 120 it generates suction via Bernoulli effect. When the sheet of air reaches the angled interior surface 122, the air attaches itself to the surface, rather than continuing straight, due to the Coanda effect. As a result, the air exhausts in the upward direction indicated by the arrow. The air flow generated using this process generates low pressure along lip 120 and the angled interior surface 122, and generates low pressure under the through-hole 118. The low pressure along with any entrained air creates a suction that enables an operator to lift and/or hold various objects (e.g., fabrics, metal sheets, plastic sheets) against the lower cover 106.

In some embodiments, as shown in FIGS. 1-4, the lower cover 106 has a generally ring structure and one or more crossbars 108 extending from one side of the ring structure to an opposite side. In some embodiments, the lower cover 106 includes a plurality of crossbars 108, which collectively form a grill over the through-hole 118. In some embodiments, for example, the lower cover 106 having a plurality of crossbars 108 is used to prevent flexible objects (such as fabric) from being sucked into the through-hole 118 and exhausted upwards following the airflow. The plurality of crossbars 108 can be arranged in any suitable manner. For example, configurations such as a grid pattern, diamond pattern, or other are contemplated.

The gripper 100 provides several advantages over existing devices. For example, the configuration of the pocket 130, the channel 132, the lip 120, and angled interior surface 122 creates a low pressure zone that is strongest (lowest pressure) close to the edge of the lip 120. Furthermore, when an object is actively held by the gripper 100 and the gripper is moved to another location, the motion of the surrounding air (i.e., the air coming in between the object and the gripper) due to that motion is aligned with and contributes to the flow of the air within the gripper, thereby increasing the suction rather than counteracting it. This is the opposite effect to what would happen if the air flowing through the gripper 100 exited at a position away from the center (i.e., from the center-to-periphery instead of from periphery-to-center). Another advantage is that more air is entrained due to the Coanda effect created by the lip 120 and angled interior surface 122, which results in a larger airflow and a greater lift on the object.

In various embodiments, as shown in FIGS. 8-14, an edge gripper 200 is provided. In some embodiments, the edge gripper 200 comprises a plurality of components that are operatively coupled together to provide a functional gripping device. In some embodiments, for example, the edge gripper 200 comprises an upper body 202, a lower body 204 configured to releasably couple to the upper body 202, and a guide attachment 206 configured to releasably couple to the upper body 202.

In some embodiments, as shown in FIGS. 8 and 12-14, the upper body 202 comprises a generally rectangular prism shape, including a top face 201 having an access well 226. The well 226 can have any suitable size, shape, and/or geometry. In some embodiments, the well 226 is generally cylindrical. In some embodiments, the well 226 is an opening that is in fluid communication with a gas storage 224 located within the interior core of the upper body 202. In some embodiments, for example, the edge gripper 200 is coupled to a gas feed line that is configured to be coupled to the well 226 and to deliver gas to the well 226. In such embodiments, the gas (e.g., compressed air) can be forced into the well 226 and then delivered to the storage 224. In some embodiments, the well 226 receives compressed air having has pressure in the range of 10-150 PSI, 20-120 PSI, or any subrange or value therein. In some embodiments, the well 226 provides access to the storage 224. The storage 224 can have any suitable size and shape (e.g., generally cylindrical), wherein the suitability is based on the desired volume of gas and the desired pressure of the gas containing within the storage 224. In some embodiments, the storage 224 comprises a duct 222 that allows the gas stored in the storage 224 to exit. In some embodiments, the duct 222 is oriented and positioned within the upper body 202 transverse to the orientation of the well 226.

In some embodiments, as shown in FIGS. 8, 10, and 14, the upper body 202 comprises a front face 203 having a plurality of fins 212 projecting outward from an upper portion of the front face. In such embodiments, the generally rectangular prism shape is modified by the plurality of fins 212. In some embodiments, the fins 212 project outward from the front face 203 and have an first side (upper end) that is coplanar with the top face 201, as shown in the FIGS. 8-10 and 12-14. In some embodiments, the plurality of fins 212 are spaced apart and the spaced distance between adjacent fins defines a plurality of channels 210. The size, i.e. width, of each respective channel 210 is defined by the spacing between adjacent fins 212. In some embodiments, the width of each of the channels 210 is identical. In some embodiments, the respective channels 210 have different widths. In various embodiments, the plurality of fins 212 provide a surface for objects to contact and the plurality of channels 210 provide areas that allow air to flow between the object in contact with the fins and the front face.

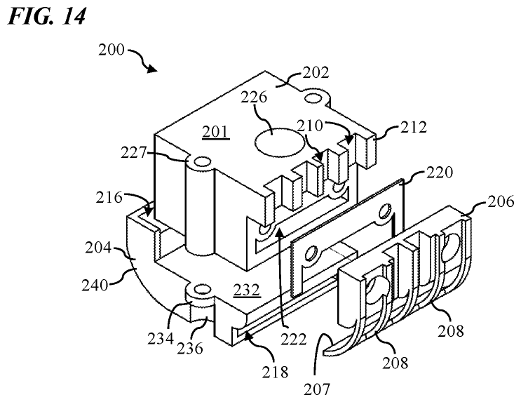

In some embodiments, as shown in FIGS. 8, 9, and 14, the lower body 204 is coupled via its top face 232 (FIG. 14) to a bottom face of the upper body 202, the bottom face being the side opposite the top face 201. In some embodiments, the lower body 204 is removably coupled to the upper body 202 using one or more fasteners. For example, as shown in FIG. 14, the upper body 202 comprises an abridged cylinder 227 (having a semi-circular cross-sectional shape) projecting outward from its left and right sides, and the lower body 204 comprises a corresponding loop 234 with a through-hole projecting outward from its left and right sides. In such embodiments, a fastener can be inserted through the through-holes on the cylinder 227 and the loop 234 to removably couple the upper body 202 and the lower body 204 to one another. In some embodiments, the left and right sides of the lower body 204 include a recess 236 that provides space for a fastener used to couple the upper body 202 and the lower body 204 to one another. In some embodiments, as shown in FIGS. 8, 9, 13, and 14, the lower body 204 comprises a sidelong J-shape in which the curve of the J corresponds to the curved edge 240 of the lower body 204. The curved edge 240 can have a predetermined length and geometry. In some embodiments, for example, the curved edge 240 has a quarter cylinder shape having a radius in a range of 2-20, or 2.5-10 mm, or 3-8 mm, or any value therein (e.g., 4 mm, 5 mm, 6 mm). In some embodiments, for example, the curved edge 240 has a half cylinder shape. In some embodiments, for example, the curved edge 240 is comprised of a plurality of straight, sloped edges.

In some embodiments, as shown in FIGS. 8, 10, and 14, the lower body 204 includes a conduit 238 having a first opening 218 on its front face, which corresponds to the front face 203 of the upper body 202. In some embodiments, the first opening 218 has a height in a range of 5 mm to 50 mm, including any subranges (e.g., 5 mm to 30 mm) or specific values therein (e.g., 6 mm, 9.5 mm). As shown in the cross-section view in FIG. 13, the conduit 238 extends from the first opening 218 on the front face, through the lower body, to a second opening 216. The conduit 238 is configured to allow gases, such as air, to flow through the lower body 204. During use, for example, air will enter the first opening 218, pass through the conduit 238, and exit the second opening 216. In some embodiments, the second opening 216 is used to redirect the air upwards. In some embodiments, the second opening 216 causes an increase in the lift and airflow at the front of the edge gripper 200. In some embodiments, the front face of the lower body 204 includes a curved protrusion 230. As shown in FIGS. 8, 10, and 14, the curved protrusion 230 is positioned above the first opening 218, whereby the curved protrusion 230 includes a first end at the top face 232, as shown in FIG. 14, and a second end at the first opening 218, as shown in FIG. 13.

In some embodiments, a guide attachment 206 is coupled to the front face 203 of the edge gripper 200. In some embodiments, the guide attachment 206 comprises one or more through-holes and is coupled to the front face 203 with one or more fasteners via the respective through-holes.

In some embodiments, the guide attachment 206 comprises a plurality of tines 208 that project downward from a guide body 205 to a cross member 207. In some embodiments, the respective tines 208 are spaced apart from one another. In some embodiments, the tines 208 are each spaced apart by an equal distance. In some embodiments, the spacing between each of the adjacent tines 208 is different, or not identical. In some embodiments, the plurality of tines 208 are spaced apart and the spaced distance between adjacent tines defines a plurality of gaps 228. The size, i.e. width, of each respective gap 228 is defined by the spacing between adjacent tines 208. In some embodiments, the tines 208 have an elongate structure that projects downward from the guide body 205 and then curves inward toward the first opening 218 of the lower body 204, as shown in FIGS. 8, 9, 13, and 14. In some embodiments, the curvature of the plurality of tines 208 is the same or substantially the same as the curved edge 240 of the lower body 204. In some embodiments, as shown in FIGS. 8, 9, 13, and 14, the plurality of tines 208 extend to, without contacting, the front face of the lower body 204. In such embodiments, there is a gap 216 between the respective tines 208 and the front face of the lower body 204.

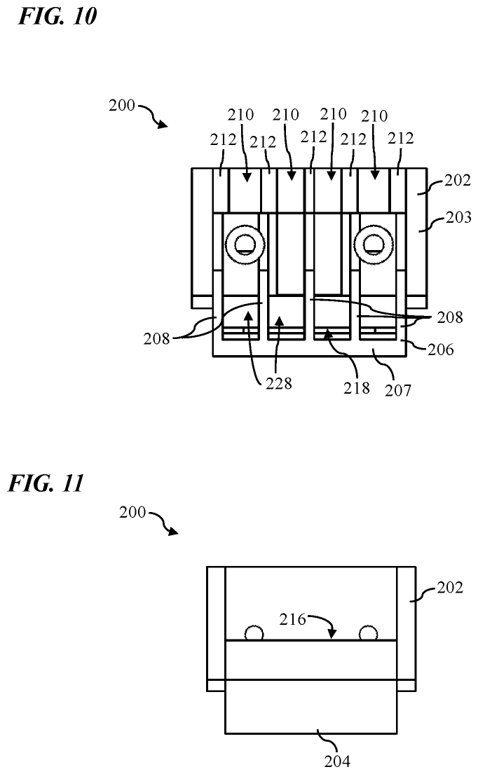

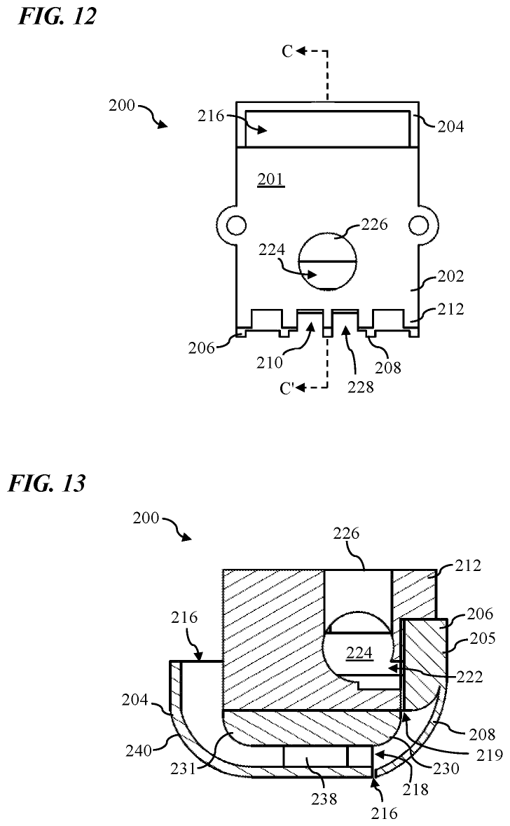

In some embodiments, as shown in FIGS. 8, 10, and 12, one or more of the plurality of tines 208 are oriented and positioned in alignment with one or more of the plurality of fins 212. For example, as shown in the front view of FIG. 10, one or more of the fins 212 and the tines 208 are oriented vertically and aligned with one another. In some embodiments, the positioning of one or more of the plurality of tines 208 overlaps with the positioning of one or more of the plurality of fins 212. For example, as shown in the front view of FIG. 10, one or more of the fins 212 and the tines 208 are oriented vertically and aligned to overlap with one another. And, as shown in the top view of FIG. 12, one or more of the tines 208 is positioned about the front face 203 such that there is overlap with one or more of the fins 212. In such embodiments, one or more of the channels 210 between adjacent fins 212 overlap with one or more gaps 228 of the guide attachment 206.

In some embodiments, the edge gripper 200 comprises a spacer 220 positioned between the front face of the upper body 202 and the guide attachment 206. In some embodiments, the spacer 220 is removable. In some embodiments, spacer 220 is integrated into the upper body 202 and indivisible from it. In various embodiments, the spacer 220 is configured to create a thin opening for air to exit the storage 224 via the duct 222 and the vent 219. In some embodiments, the thickness of the spacer 220 will determines the size of the opening for the vent 219. In various embodiments, the spacer 220 is configured to seal and prevent air from escaping anywhere except for the storage 224 via the duct 222.

In various embodiments, during use, the edge gripper 200 receives compressed air as an input and produces a thin sheet of air as an output. In some embodiments, the compressed air fills the storage 224 and pressure builds up in the storage 224 before air exits through the duct 222. In such embodiments, the air then passes toward the vent 219 and the thin sheet of air is created by the vent 219. As the air exits the vent 219, it encounters the curved protrusion 230, which redirects the airflow via the Coanda effect. The redirected sheet of air and any air that is entrained therewith enters the conduit 238 via the first opening 218, flows through the conduit 238, and then is exhausted out of the second opening 216. A low pressure of air created by the storage 224 and the duct 222, along with entrained airflow, creates a lift on a nearby object (such as flexible and bendable piece of fabric) that causes an edge of the object to lift and be held against the lower body 204 and the guide attachment 206. Furthermore, the guide attachment 206 includes a plurality of gaps 228, which allow the entrained air to flow through them and between the plurality of tines 208. The flow of air created by the tines and gaps also generates low pressure. In such embodiments, when the edge of an object (e.g., fabric) is flush against the plurality of tines 208, the low pressure within gaps 228 generates enough force to hold the object against the edge gripper 200 while the air flows through the plurality of gaps 228.

In some embodiments, for example, when the object to be lifted is relatively large or heavy, a clamp can is utilized with the edge gripper 200 to mechanically secure the edge of the object against the lower body 204 and/or the guide attachment 206. In such embodiments, the clamp may be attached to a robotic arm (e.g., the same arm the edge gripper 200 is attached to).

In various embodiments, the edge gripper 200 provides advantages over existing systems. For example, the edge gripper 200 can lift the edge of a flexible object (e.g., a sheet of fabric) and pin it firmly against the lower body 204 and the guide attachment 206 without causing the object's edge to flap. Furthermore, depending on the porosity and stiffness of the object and its edge being lifted, the position of the second opening 216 can be adjusted relative to the curved surface 230, for example, by increasing the radius of the curved surface 230. In such embodiments, modifying the curved surface 230 creates a different pressure or lift profile that will be experienced by the object and result in a desirable lift of the edge of the object instead of the edge being crumpled and sucked towards the first opening 218. Additionally, the height of the first opening 218 can be adjusted to modify the pressure or lift profile of the edge gripper 200. For example, in some embodiments, the height of the first opening 218 is increased to accommodate lighter fabrics, or decreased to accommodate heavier fabrics. During use, an increase to the height of the opening 218 will modify the distance between the vent 219 and the object being lifted, which in turn modifies the pressure and air flow experienced by the object (e.g., a light and pliant fabric). In such embodiments, the object will experience a stronger vertical lift rather than a stronger horizontal lift. In this context, a strong horizontal lift would cause a relatively light fabric to crumple as it is being sucked towards 218 instead of curving, uncrumpled, over the components of the guide attachment 206.

In various embodiments, as shown in FIG. 15 and FIG. 16, a destacker assembly 300 is provided. In some embodiments, the destacker assembly 300 is a system configured to remove a single ply of material (e.g., a flexible piece of fabric) from a stack having multiple plies of material (e.g., 50 plies). In some embodiments, the destacker assembly 300 comprises one or more edge grippers 200 and one or more fingers 308. In some embodiments, the one or more edge grippers 200 and the one or more fingers 308 are independently coupled to a carriage 303 via a first bracket 304 and a second bracket 306, respectively. In some embodiments, the destacker assembly 300 comprises a housing 302 that is configured to cover the upper surface of the carriage 303 and/or any components attached thereto.

In various embodiments of the destacker assembly 300, the edge gripper 200 and/or the finger 308 is stationary. In various embodiments of the destacker assembly 300, the edge gripper 200 and/or the finger 308 is moveable. In some embodiments, the edge gripper 200 is stationary and the finger 308 is moveable. In some embodiments, the edge gripper 200 is moveable and the finger 308 is stationary. In some embodiments, the destacker assembly 300 comprises a mechanism for moving an edge gripper of the one or more edge grippers 200 and a finger of the one or more fingers 308 toward and away from one another. In some embodiments, for example, when the edge gripper 200 is stationary and the finger 308 is moveable, the carriage 303 is configured with a track that allows the finger 308 to move laterally toward the edge gripper 200.

In some embodiments, the finger 308 comprises a top face having an access well. The well can have any suitable size, shape, and/or geometry. In some embodiments, the well is generally cylindrical. In some embodiments, the well is an opening that is in fluid communication with a passage and/or a gas storage located within the interior core of the finger 308. In some embodiments, for example, the finger 308 is coupled to a gas feed line that is configured to be coupled to the well and to deliver gas to the well. In such embodiments, the gas (e.g., compressed air) can be forced into the well. In some embodiments, the finger 308 comprises a nozzle for releasing the gas delivered to the finger. During use, the nozzle can be activated to deliver a stream of gas toward an object positioned below and/or in contact with the finger 308.

In some embodiments, the destacker assembly 300 comprises one or more sensors. In some embodiments, one of more sensors can be configured to determine how close the edge gripper 200 is to the finger 308 during use. In some embodiments, one of more sensors can be configured to determine how close the edge gripper 200 and/or the finger 308 are to a target object. In some embodiments, one of more sensors can be configured to determine how many plies of material have been lifted by the one or more edge grippers 200 of the destacker assembly 300.

In various embodiments, the destacker assembly 300 provides advantages over existing systems. For example, the destacker assembly 300 can pick up an edge of a ply of material from a stack having multiple plies of material, secure the edge in a fixed position, and then separate the ply of material from the ply or multiple plies beneath it in the stack. The destacker assembly 300 therefore increases the probability of a successful destacking operation because the edge gripper 200 is not engaging all the forces that may be binding two or more plies together at the same time. In some embodiments, a second edge gripper 200 or finger 308 can be used to remove any plies stuck to the top ply, which further increasing the probability of a successful destacking operation.

In various embodiments, a method of using the destacker assembly 300 to lift a single ply of fabric from a stack comprised of multiple fabrics is provided. In some embodiments, a sequence of method steps for a ply removal process is shown in FIGS. 17A-17D. In some embodiments, as shown in FIG. 17A, the method includes a step of lowering the destacker assembly 300 towards the stack of fabrics have a ply P on top. In some embodiments, the destacker assembly 300 has a sensor that signals to the system when the stack of fabrics has been reached. In some embodiments, the compressed air is activated and air is delivered to the edge gripper 200 via the gas feed line 310, which causes the edge of the top ply P to lift upward, as shown in FIG. 17B. In some embodiments, the destacker assembly 300 has a sensor configured to determine the presence of one or multiple lifted edges of ply. After the edge of the top ply P has been lifted toward the edge gripper 200, the system moves the finger 308 towards the edge gripper 200 to mechanically clamp and secure the lifted edge of the ply P, as shown in FIG. 17C. After the edge of the ply P is secured, the compressed air can be deactivated. Next, with the edge of the ply P mechanically clamped, the destacker assembly 300 can move in various directions to separate the top ply P from the stack. As shown in FIG. 17D, the destacker assembly 300 can move upward to cause the separation.

In various embodiments, a method of using the destacker assembly 300 to separate a first ply P1 of fabric from one or more other plies, including a second ply P2, is provided. This method is useful, for example, when the plies of fabric are stuck together, or prone to stick together, for one or more reasons, including the material the fabric is made of, static attractions, etc. The method is particularly useful in manufacturing processes to guarantee that only a single ply is picked up from a stack of plies.

FIGS. 18A-18D shows a sequence of method steps for a ply separation process when multiple fabric plies are stuck together. As shown in FIG. 18A, the ply edges from the first ply P1 and the second ply P2 are stuck together when the edge gripper 200 is activated. In some embodiments, the destacker assembly 300 comprises a sensor that is configured to determine the presence of two or more plies have been lifted after the step in FIG. 18A. In such embodiments, the sensor sends a signal to the system to initiate the ply separation procedure in FIGS. 18B-18D. In some embodiments, the ply separation procedure in FIGS. 18B-18D is performed during each cycle (e.g., without a sensor). In some embodiments, as shown in FIG. 18B, the finger 308 begins to move towards the edge gripper 200. At a predetermined approach distance between the finger 308 and the edge gripper 200, as shown in FIG. 18C, the finger 308 receives compressed air via the gas supply line 312 and delivers a sequence of air bursts that separate the second ply P2 from the first ply P1 without removing the first ply P1 from the edge gripper 200. After the additional plies of material, including the second ply P2, have been separated from the first ply P1, the finger 308 completes its motion towards the edge gripper 200 and mechanically clamps the edge of the ply P1 between the edge gripper 200 and the finger 308. After the edge of the first ply P1 is secured, the compressed air can be deactivated. Next, with the edge of the first ply P1 mechanically clamped, the destacker assembly 300 can move in various directions to separate the first ply P1 from the stack of plies. As shown in FIG. 18D, the destacker assembly 300 can move upward to cause the separation.

As one of skill would appreciate that the methods disclosed herein may be carried out with or without one or more of the specific steps discussed in this disclosure. In various embodiments, one or more steps of the method may be omitted.

The foregoing embodiments are provided to aid in the understanding of the present disclosure, the true scope of which is set forth in the appended claims. One of skill in the art would appreciate that modifications can be made in the embodiments set forth without departing from the spirit of the disclosure.

Exemplary embodiments and examples of the products, systems, and methods are described above in detail. The products, systems, and methods are not limited to the specific embodiments described herein, but rather, components of the products and systems and/or steps of the method may be utilized independently and separately from other components and/or steps described herein. For example, the system may also be used in combination with other products and methods, and is not limited to practice with only a product as described herein. Rather, the exemplary embodiment can be implemented and utilized in connection with many other systems.

A recitation of ranges of values herein are merely intended to serve as a shorthand method of referring individually to each separate value falling within the range, unless otherwise indicated herein, and each separate value is incorporated into the specification as if it were individually recited herein. As will be understood by one skilled in the art, ranges disclosed herein encompass any and all possible subranges and combinations of subranges thereof. Any listed range can be easily recognized as sufficiently describing the same range being broken down into at least equal halves, thirds, quarters, fifths, tenths, etc. For example, a range of 2% to 3% includes 2.3% to 2.8%, 2.4% to 2.9%, etc. As a non-limiting example, each range discussed herein can be readily broken down into a lower third, middle third and upper third, etc. As will also be understood by one skilled in the art, language such as “up to,” “at least,” “greater than,” “less than,” and the like include the number recited and refer to ranges which can be subsequently broken down into subranges as discussed above. Finally, as will be understood by one skilled in the art, a range includes each endpoint and individual member. For example, a range of 4% to 10% includes the subranges 5% to 9%, 6% to 8%, etc., and each endpoint (e.g., 4%, 5%, 6%, 8%, 9%, 10%) can be recited as an individual limitation.

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context.

As used herein, the use of examples, or exemplary language (e.g., “such as”), is intended to illuminate the embodiments and does not pose a limitation on the scope of the claims unless otherwise stated. No language in the specification should be construed as indicating any non-claimed element as essential.

As used herein, the terms “about” and “substantially” will be understood by persons of ordinary skill in the art and will vary to some extent depending upon the context in which it is used. If there are uses of the term which are not clear to persons of ordinary skill in the art, given the context in which it is used, “about” and “substantially” will mean up to plus or minus 10% of the particular term.

This written description uses examples to disclose the present embodiments, including the best mode, and to enable any person skilled in the art to practice the present embodiments, including carrying out the steps of the method. The patentable scope of the present embodiments is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

I/We claim:

1. An air gripper configured to lift an object, comprising:
a body having an annular shape modified by a joint projecting from a side of the body;
an upper cover releasably coupled to a first surface of the body;
a lower cover releasably coupled to a second surface of the body; and
a through-hole extending through the body, the upper cover, and the lower cover, the through-hole having a truncated conical shape defined by a base at the second surface of the body and an apex at the first surface of the body;
wherein the body comprises a pocket configured to receive an input of gas and an annular channel in fluid communication with the pocket; and
wherein the annular channel is in fluid communication with a surface of the through-hole via a gap between the body and the lower cover.

2. The air gripper of claim 1, wherein the truncated conical shape of the through-hole defines an interior annular surface of the body, the interior annular surface being pitched at an angle in a range of 30-80 degrees from the base to the apex.

3. The air gripper of claim 1, wherein the interior annular surface has a slope at an angle in a range of 40-60 degrees from the base to the apex.

4. The air gripper of claim 1, wherein the pocket is centered between lateral edges of the joint and positioned at least partially within the joint.

5. The air gripper of claim 1, wherein the lower cover comprises one or more crossbars extending over the through-hole from one side of the lower cover to an opposite side.

6. The air gripper of claim 1, further comprising a spacer between the lower cover and the body.

7. The air gripper of claim 6, wherein the spacer has a thickness that defines the gap between the body and the lower cover.

8. The air gripper of claim 2, wherein a suction for lifting the object is created in the through-hole when the input of gas flows from the pocket through the annular channel, through the gap between the body and the lower cover, and to the interior annular surface of the body.

9. An edge gripper configured to lift an edge of an object, comprising:
an upper body comprising a top face having an access well configured to receive an input of gas, the well being in fluid communication with a gas storage located within an interior core of the upper body, and the gas storage being in fluid communication with a duct extending from the gas storage to a front face of the upper body;
a lower body releasably coupled to the upper body at a bottom face opposite the top face, the lower body comprising a conduit having a first opening on a front face corresponding to the front face of the upper body, wherein the conduit extends through the lower body to a second opening adjacent to a rear face of the lower body opposite the front face;
a guide attachment releasably coupled to the front face of the upper body, the guide attachment having a plurality of tines projecting downward from a guide body and curving toward a cross member positioned in proximity to the first opening of the conduit in the lower body; and
a vent positioned between the front face of the upper body and the guide body of the guide attachment, the vent being in fluid communication with the duct in the upper body.

10. The edge gripper of claim 9, wherein the lower body comprises a sidelong J-shape with a curve of the sidelong J-shape ending at the second opening of the conduit; and
wherein the lower body further comprises a curved protrusion on the front face, the curved protrusion being adjacent to the first opening of the conduit.

11. The edge gripper of claim 9, wherein respective tines of the plurality of tines on are spaced apart from one another by a spaced distance that defines a plurality of gaps, wherein respective gaps of the plurality of gaps are positioned between adjacent tines.

12. The edge gripper of claim 9, further comprising a plurality of fins projecting outward from the front face of the upper body.

13. The edge gripper of claim 12, wherein the plurality of fins are spaced apart from one another by a spaced distance that defines a plurality of channels, wherein the respective channels are positioned between adjacent fins.

14. The edge gripper of claim 12, wherein the guide body of the guide attachment is in contact with the plurality of fins.

15. The edge gripper of claim 10, wherein a suction for lifting the edge of the object is created in the conduit of the lower body when the input of gas flows from the gas storage through the duct, through the vent between the upper body and the guide assembly, and along the curved protrusion on the front face of the lower body toward the first opening of the conduit.

16. The edge gripper of claim 9, further comprising a spacer positioned between the upper body and the guide attachment, wherein the thickness of the spacer defines the vent between the front face of the upper body and the guide body of the guide attachment.

17. A destacker assembly, comprising:
a carriage, an edge gripper coupled to a first face of the carriage, and a finger coupled to the first face of the carriage;
wherein the edge gripper comprises:
an upper body comprising a top face having an access well configured to receive an input of gas, the well being in fluid communication with a gas storage located within an interior core of the upper body, and the gas storage being in fluid communication with a duct extending from the gas storage to a front face of the upper body;
a lower body releasably coupled to the upper body at a bottom face opposite the top face, the lower body comprising a conduit having a first opening on a front face corresponding to the front face of the upper body, wherein the conduit extends through the lower body to a second opening adjacent to a rear face of the lower body opposite the front face;
a guide attachment releasably coupled to the front face of the upper body, the guide attachment having a plurality of tines projecting downward from a guide body and curving toward a cross member positioned in proximity to the first opening of the conduit in the lower body; and
a vent positioned between the front face of the upper body and the guide body of the guide attachment, the vent being in fluid communication with the duct in the upper body; and
wherein the finger comprises a top face having an access well for receiving an input of gas, the well being in fluid communication with a passage within an interior core of the finger, and the passage being in fluid communication with an outlet that can release the gas via a bottom face of the finger, the bottom face being opposite to the top face; and
wherein the carriage comprises a first bracket for coupling the edge gripper to the first face of the carriage and a second bracket for coupling the finger to the first face of the carriage.

18. The destacker assembly of claim 17, wherein the finger and second bracket are moveable about the first face of the carriage, and
wherein the finger and second bracket are configured to move laterally toward and away from the edge gripper.

19. The destacker assembly of claim 18, wherein the edge gripper and the finger are configured to lift and move a single ply of a material from a stack having multiple plies of the material.

20. The destacker assembly of claim 18, wherein the edge gripper and the finger are configured to separate a first ply of a material from one or more other plies of the material.
